(19) United States
(12) Patent Application Publication
(10) Pub. No.: US 2026/0344725 A1
(43) Pub. Date: Nov. 5, 2026

(54) LIQUID NUTRITIONAL EMULSION STABILIZED BY ALCOHOL-WASHED SOY PROTEIN CONCENTRATE AND PREPARATION METHOD FOR LIQUID NUTRITIONAL EMULSION

(71) Applicants: SOUTH CHINA UNIVERSITY OF TECHNOLOGY, Guangzhou, Guangdong (CN); SOUTH CHINA INSTITUTE OF COLLABORATIVE INNOVATION, Dongguan, Guangdong (CN)

(72) Inventors: Zhili WAN, Guangzhou (CN); Yuqi MEI, Guangzhou (CN); Yunyi YANG, Guangzhou (CN); Jiguo YANG, Dongguan (CN); Xiaoquan YANG, Guangzhou (CN)

(73) Assignees: SOUTH CHINA UNIVERSITY OF TECHNOLOGY, Guangzhou, Guangdong (CN); SOUTH CHINA INSTITUTE OF COLLABORATIVE INNOVATION, Dongguan, Guangdong (CN)

(21) Appl. No.: 19/488,831

(22) PCT Filed: Oct. 30, 2023
(86) PCT No.: PCT/CN2023/127942

§ 371 Date: Nov. 30, 2025

(30) Foreign Application Priority Data
May 31, 2023 (CN) 202310641878.2

(51) Int. Cl. A23L 33/185; A23J 3/16; A23J 3/34; A23L 33/115; A23L 33/125; A23L 33/155; A23L 33/16; A23L 33/18; A23L 33/21

(52) U.S. Cl. CPC A23L 33/185; A23J 3/16; A23J 3/346; A23L 33/115; A23L 33/125; A23L 33/155; A23L 33/16; A23L 33/18; A23L 33/21

(57) ABSTRACT

A liquid nutritional emulsion stabilized by an alcohol-washed soy protein concentrate and a preparation method for the liquid nutritional emulsion. Every 100 ml of the liquid nutritional emulsion comprises 2-8 g of an alcohol-washed soy protein concentrate, 5-10 g of carbohydrate, 2-4 g of dietary fiber, 4-8 g of grease, 0.05-0.2 g of a multivitamin, and 0.5-2 g of a complex mineral. The preparation method for the liquid nutritional emulsion comprises performing pretreatment and enzymolysis on the alcohol-washed soy protein concentrate, respectively preparing a water phase and an oil phase, and carrying out mixing, homogenizing, high-pressure microfluidization, and sterilization. Further comprised is a use of the nutritional emulsion in RTD-type health-care foods, sports nutrition foods or foods for special medical purposes.

### FIELD OF THE INVENTION

The present disclosure belongs to the technical field of nutritional food preparations, and in particular, relates to a liquid nutritional emulsion stabilized by alcohol-washed soybean protein concentrate and a preparation method therefor.

### BACKGROUND OF THE INVENTION

Currently, the protein sources in most commercial high-protein nutritional emulsions are either a single protein (e.g., whey protein or casein), or a mixture of one or both therein with soybean protein isolate. Soybean protein isolate is the most commonly used plant protein raw material. However, the production of soybean protein isolate with high protein content often results in significant consumption and waste of raw materials, and a large amount of waste residue and organic wastewater are generated.

Compared with soybean protein isolate, alcohol-washed soybean protein concentrate is cheaper and has a lower beany odor. Meanwhile, the alcohol-washed soybean protein concentrate has a higher nutritional value, with basically unchanged amino acid composition and content compared to soybean meal. Moreover, anti-nutritional factors, allergens, and protease inhibitors can be effectively removed from soybeans by means of ethanol extraction. In the production process of the alcohol-washed soybean protein concentrate, the wastewater discharge amount is low, which is environmentally friendly. In addition, most of the color-producing and flavor-producing substances are removed during the ethanol extraction process, resulting in excellent color and flavor of the alcohol-washed soybean protein concentrate. With the development of society and the increasing environmental awareness among people, the alcohol-washed soybean protein concentrate is gaining increasing attention due to its green and pollution-free production process. In terms of application, the alcohol-washed soybean protein concentrate is widely used in the production of meat products and flour products due to its strong water-holding capacity, oil-holding capacity, and higher viscosity. However, the low solubility and insufficient emulsifying property of the alcohol-washed soybean protein concentrate limit its wide use in the food industry. Some researchers have modified alcohol-washed soybean protein concentrate to prepare emulsified liquids (Tian Shaojun, Yang Min, Guo Xingfeng, and Xiao Jian, “Comparative study on functionality and microstructure of alcohol-washed soybean protein concentrate modified by different physical methods” [J]. China Oils and Fats, 2008(07):27-31). However, there are problems such as insufficient emulsifying property, tendency to form flocculation and precipitation after sterilization, and a short shelf life of the alcohol-washed soybean protein concentrate, making large-scale industrial production difficult.

Therefore, developing a nutritional emulsion using the alcohol-washed soybean protein concentrate as a main raw material to improve its emulsifying property and emulsifying stability is of great significance for enhancing the commercial value and broadening the application field of the alcohol-washed soybean protein concentrate.

### SUMMARY OF THE INVENTION

To overcome the shortcomings and deficiencies of the prior art, the present disclosure aims to provide a liquid nutritional emulsion stabilized by alcohol-washed soybean protein concentrate and a preparation method therefor. In the present disclosure, the solubility and emulsifying characteristics of the alcohol-washed soybean protein concentrate are improved through pretreatment and enzymatic hydrolysis of the alcohol-washed soybean protein concentrate. A carbohydrate, fat, vitamins, and minerals are compounded in a specific proportion to obtain a high-protein nutritional emulsion. The nutritional emulsion may remain stable at room temperature for a long time without flocculation, precipitation, and phase separation, solving the problems of insufficient emulsifying property and poor emulsifying stability of the alcohol-washed soybean protein concentrate, thereby helping enhance the commercial value of the alcohol-washed soybean protein concentrate.

The objects of the present disclosure are realized by the following technical solutions.

A liquid nutritional emulsion stabilized by alcohol-washed soybean protein concentrate is provided, including 2-8 g/100 ml of alcohol-washed soybean protein concentrate, 5-10 g/100 ml of a carbohydrate, 2-4 g/100 ml of a dietary fiber, 4-8 g/100 ml of a lipid, 0.05-0.2 g/100 ml of multivitamin, and 0.5-2 g/100 ml of complex minerals.

The alcohol-washed soybean protein concentrate has a protein content of 68%-80% and a lower NSI of 5%-12%.

Before use, the alcohol-washed soybean protein concentrate is subjected to pretreatment and enzymatic hydrolysis, to improve the emulsifying ability of the alcohol-washed soybean protein concentrate. Due to denaturation and aggregation of protein caused by ethanol solution, the solubility of the alcohol-washed soybean protein concentrate is greatly reduced. Through the pretreatment and the enzymatic hydrolysis, the particle size of the protein is greatly reduced, and the structure is unfolded so that some proteins become short peptides, the molecular weight thereof becomes smaller, and the solubility thereof increases accordingly. The solubility plays a crucial role on the emulsifying property of proteins.

The pretreatment includes one or more of ultrasonic treatment, high-pressure microfluidization, hydrodynamic cavitation, and ball milling. The ultrasonic treatment is performed for 8-12 min at a power of 400-600 W. The high-pressure microfluidization is performed through homogenization for 2-3 times at 50-100 MPa. The hydrodynamic cavitation is performed for 10-30 min. The ball milling is performed for 0.5-1.5 h. A rotating speed of a ball mill is 200-400 r/min.

Preferably, the pretreatment method involves dry ball milling of the alcohol-washed soybean protein concentrate for 0.5-1 h, followed by hydrodynamic cavitation for 10-20 min.

After pretreatment of the alcohol-washed soybean protein concentrate, enzymatic hydrolysis is performed. An enzyme used is neutral protease. An addition amount of the enzyme is 0.4%-4% of the protein mass, time for the enzymatic hydrolysis is 0.5-4 h, and temperature for the enzymatic hydrolysis is 40-70 °C. After the enzymatic hydrolysis, the enzyme is inactivated in a water bath at 89-95 °C for 10 min to terminate the reaction.

The carbohydrate is one or more selected from a group consisting of maltodextrin, trehalose, corn starch, glucose, sucrose, lactose, polydextrose, inulin, and isomaltooligosaccharide.

The carbohydrate is one or more selected from a group consisting of maltodextrin, trehalose, corn starch, glucose, sucrose, and lactose.

The dietary fiber is one or more selected from a group consisting of resistant dextrin, galactooligosaccharide, fructooligosaccharide, polyfructosan, polydextrose, raffinose, and inulin.

The lipid is one or more selected from a group consisting of corn oil, sunflower seed oil, soybean oil, low-erucic-acid rapeseed oil, sesame oil, sea buckthorn oil, linseed oil, coconut oil, olive oil, perilla oil, palm oil, walnut oil, rice bran oil, camellia seed oil, fish oil, and medium chain triglyceride.

The nutritional emulsion includes 0.05-0.2 g/100 ml of the multivitamin.

The vitamins include an oil-soluble vitamin and a water-soluble vitamin, and specifically include vitamin A, vitamin C, vitamin D, vitamin E, vitamin K, vitamin B₁, vitamin B₂, vitamin B₆, vitamin B₁₂, niacins, folic acid, pantothenic acid, and biotin.

The water-soluble vitamin includes vitamin B₁, vitamin B₂, vitamin B₆, vitamin B₁₂, niacin, folic acid, pantothenic acid, vitamin C, and biotin. The oil-soluble vitamin includes vitamin A, vitamin D, vitamin E, and vitamin K₁.

Contents of various vitamins in the multivitamin per 100 mL of the nutritional emulsion are as follows: vitamin A 28.2-242.1 μg RE, vitamin D 0.57-3.385 μg, vitamin E 0.57-2.25 mg α-TE, vitamin K₁ 3.15-4.5 μg, vitamin B₁ 0.06-0.9 mg, vitamin B₂ 0.06-0.9 mg, vitamin B₆ 0.06-0.9 mg, vitamin B₁₂ 0.09-1.35 μg, niacin 0.15-1.8 mg, folic acid 15.9-45 μg, pantothenic acid 0.21-2.7 mg, vitamin C 3.9-40.5 mg, and biotin 1.5-5.4 μg.

The nutritional emulsion includes 0.5-2 g/100 ml of the complex minerals.

The minerals include sodium, potassium, copper, magnesium, iron, zinc, manganese, calcium, phosphorus, iodine, chlorine, and selenium salts.

Contents of the minerals per 100 mL of the nutritional emulsion are as follows: sodium 60-270 mg, potassium 81-315 mg, copper 33-270 μg, magnesium 13.2-135 mg, iron 0.6-2.48 mg, zinc 0.3-2.25 mg, manganese 18-540 μg, calcium 39-135 mg, phosphorus 28.8-90 mg, iodine 4.8-54 μg, chlorine 1.2-234 mg, and selenium 2.4-23.9 μg.

A preparation method for the nutritional emulsion includes the following steps:
(1) mixing a alcohol-washed soybean protein concentrate with water, performing pretreatment and enzymatic hydrolysis, then adding a carbohydrate, a dietary fiber, a water-soluble vitamin, and a mineral, and adjusting the pH to 6.5-7 to obtain an aqueous phase;
(2) adding an oil-soluble vitamin to a lipid, and mixing them uniformly to obtain an oil phase; and
(3) mixing the aqueous phase and the oil phase, performing pre-homogenization shearing for 1-5 min at a rotating speed of 3,000-10,000 rpm, and then performing high-pressure microfluidization for 2-4 times at a condition of 30-100 MPa, followed by sterilization, to obtain the nutritional emulsion.

The sterilization refers to high-pressure steam sterilization at a temperature of 110-125 °C for 5-15 min.

Use of the nutritional emulsion in RTD-type health food, sports nutritional food, or food for special medical purposes is provided.

The high-protein nutritional emulsion of the present disclosure has the following advantages.
(1) In the present disclosure, the alcohol-washed soybean protein concentrate is applied to the production and preparation of the nutritional emulsion. The nutritional emulsion remains stable at room temperature for a long time without flocculation, precipitation, and phase separation, solving the problems of insufficient emulsifying property and poor emulsifying stability of the alcohol-washed soybean protein concentrate.
(2) The product is in emulsion form and can be consumed directly without dilution.
(3) The preparation process of the emulsion of the present disclosure is relatively simple and is beneficial to large-scale industrial production.

### BRIEF DESCRIPTION OF THE DRAWINGS

FIG. 1 shows the appearance of emulsions after homogenization of samples 1-6 added with different polysaccharides/small molecules in Example 2, corresponding to samples 1-6 from left to right, respectively;

FIG. 2 shows the appearance of emulsions after homogenization of samples 7-10 through different pretreatments in Example 3, corresponding to samples 7-10 from left to right, respectively;

FIG. 3 shows the appearance of emulsions after enzymatic hydrolysis with different enzymes, homogenization, and sterilization of samples 11-14 in Example 4, corresponding to samples 11-14 from left to right, respectively; and

FIG. 4 shows the appearance of the emulsion obtained through pretreatment and enzymatic hydrolysis in Example 5 after sterilization and storage for 3 months.

### DETAILED DESCRIPTION OF THE EMBODIMENTS

To better understand the technical solutions of the present disclosure, embodiments of the present disclosure will be described in detail below with reference to Examples. Apparently, the following Examples are merely for illustrative purposes and are not intended to limit the scope of the present disclosure. If the specific conditions are not specified in the Examples, the conventional conditions or the conditions recommended by the manufacturer shall be followed. The reagents or instruments used without specifying the manufacturer are conventional products that are commercially available through regular channels. The present disclosure should not be construed as being limited to the specific Examples.

Table 1 is a table of ingredients of alcohol-washed soybean protein. Table 2 is a table of ingredients of nutritional emulsions using alcohol-washed soybean protein concentrate as a main raw material in Examples.

TABLE 1
Table of ingredients of alcohol-washed soybean protein concentrate

| | Protein | Total | | Crude | | |
|---|---|---|---|---|---|---|
| Components | (dry basis) | sugar | Fat | fiber | Moisture | Ash |
| Content/% | 69.8 | 15.8 | 0.4 | 3.2 | 5.5 | 5.3 |

TABLE 2
Table of ingredients of nutritional emulsions using alcohol-washed
soybean protein concentrate as main raw material (per 100 mL)

| Serial number | Nutrient category | Content |
|---|---|---|
| 1 | Protein (g) | 3.6 |
| 2 | Fat (g) | 5 |
| 3 | Carbohydrate (g) | 5 |
| 4 | Dietary fiber (g) | 2 |
| 5 | Vitamin (g) | 0.05 |
| 5.1 | Vitamin A (μg RE) | 60 |
| 5.2 | Vitamin D (μg) | 1.2 |
| 5.3 | Vitamin E (mg α-TE) | 1.5 |
| 5.4 | Vitamin K₁ (μg) | 3.8 |
| 5.5 | Vitamin B₁ (mg) | 0.2 |
| 5.6 | Vitamin B₂ (mg) | 0.3 |
| 5.7 | Vitamin B₆ (mg) | 0.28 |
| 5.8 | Vitamin B₁₂ (μg) | 0.28 |
| 5.9 | Niacin (mg) | 1.2 |
| 5.10 | Folic acid (μg) | 34 |
| 5.11 | Pantothenic acid (mg) | 0.7 |
| 5.12 | Vitamin C (mg) | 30 |
| 5.13 | Biotin (μg) | 5.2 |
| 6 | Mineral (g) | 0.7 |
| 6.1 | Sodium (mg) | 120 |
| 6.2 | Potassium (mg) | 168 |
| 6.3 | Copper (μg) | 108 |
| 6.4 | Magnesium (mg) | 22 |
| 6.5 | Iron (mg) | 1.6 |
| 6.6 | Zinc (mg) | 1.1 |
| 6.7 | Manganese (μg) | 310 |
| 6.8 | Calcium (mg) | 176 |
| 6.9 | Phosphorus (mg) | 58.2 |
| 6.10 | Iodine (μg) | 18 |
| 6.11 | Chlorine (mg) | 160 |
| 6.12 | Selenium (μg) | 6.72 |

### Example 1: Influence of the Addition of Different Polysaccharides/Small Molecules on Emulsified Liquids

According to Table 2, the nutritional emulsion of alcohol-washed soybean protein was prepared by adding different nutritional ingredients. The alcohol-washed soybean protein concentrate was first dispersed in pure water and hydrated for two hours to achieve complete hydration. After adding a carbohydrate (maltodextrin) and a dietary fiber (resistant dextrin), different types of polysaccharides and small molecules were added, with the specific formula shown in Table 3, to obtain an aqueous phase. Water-soluble vitamins and minerals were added to the aqueous phase, and oil-soluble vitamins were dissolved in sunflower seed oil and mixed for 0.5 h. The aqueous phase and the oil phase were mixed, and after pre-homogenization shearing at a rate of 6,000 rpm for 2 min, high-pressure microfluidization was performed for three times at a condition of 50 MPa to obtain an emulsified liquid. After the emulsified liquid was canned, high-pressure steam sterilization was performed (121 °C, 15 min) to obtain the emulsion.

Appearance evaluation of the emulsified liquid: The severity of flocculation and phase separation was evaluated after the homogenization of the emulsified liquid, and the severity of phase separation of the emulsified liquid was evaluated after sterilization at 121 °C for 15 min.

Evaluation indicators are as follows:
++++: severe floating oil, phase separation, or flocculation after homogenization or sterilization;
+++: obvious floating oil, phase separation, or flocculation after homogenization or sterilization;
++: relatively obvious floating oil, phase separation, or flocculation after homogenization or sterilization;
+: slight floating oil, phase separation, or flocculation after homogenization or sterilization; and
−: no floating oil, phase separation, or flocculation after homogenization or sterilization.

TABLE 3
Influence of addition of different polysaccharide/small
molecule stabilizers on emulsified liquids

| | | Appearance | Appearance |
|---|---|---|---|
| | Polysaccharide/small | (before | (after |
| Sample | molecule (g/100 ml) | sterilization) | sterilization) |
| 1 | 0 | ++ | ++++ |
| 2 | 0.5 carrageenan | + | ++++ |
| 3 | 0.5 xanthan gum | + | ++++ |
| 4 | 0.5 small molecular pectin | + | ++++ |
| 5 | 0.5 | + | ++++ |
| | carboxymethylcellulose | | |
| 6 | 0.5 stevioside | + | ++++ |

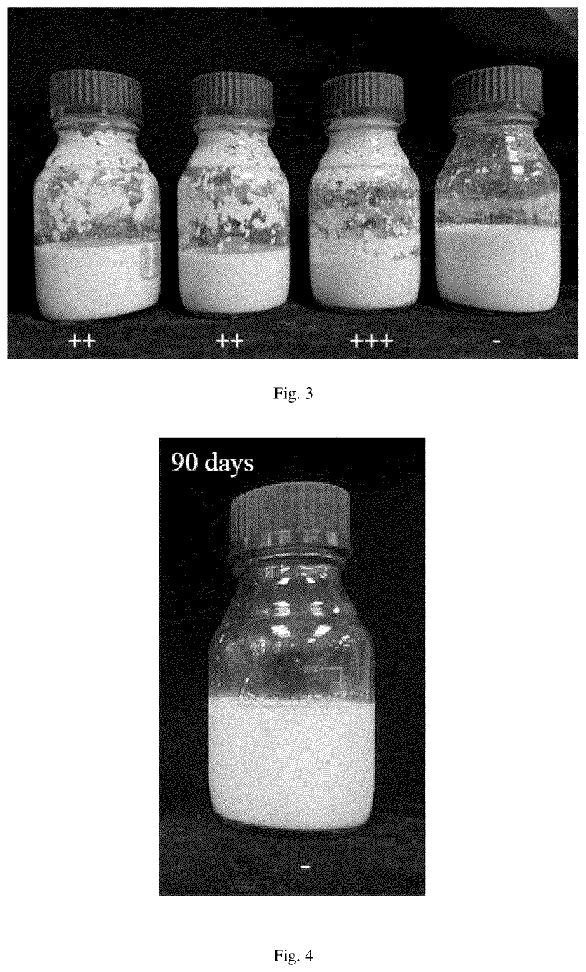

It can be seen from Table 3 that with regard to sample 1, alcohol-washed soybean protein concentrate compounded with maltodextrin is directly used as the main aqueous phase, without adding other substances (polysaccharides/small molecules). After homogenization, the appearance of the obtained emulsified liquid shows obvious floating oil, phase separation, or flocculation. After high-temperature sterilization, the degree of phase separation and flocculation becomes more serious. Samples 2-6 are emulsified liquids with different types of polysaccharide or small molecule stabilizers added. The addition of the polysaccharide or small molecule stabilizers has a certain effect on improving the stability of the emulsified liquids. However, an ideal state cannot be achieved. Before sterilization, flocculation and phase separation are still observed to a small extent at the bottom of the emulsified liquid, and the state of the emulsified liquid after high-temperature sterilization is not significantly different from that of sample 1 without the addition. The appearance of samples 1-6 before sterilization is shown in FIG. 1.

### Example 2: Preparation of Alcohol-Washed Soybean Protein Concentrate by Different Pretreatments and their Influence on Solubility of Alcohol-Washed Soybean Protein Concentrate

Ultrasonic treatment: 3.6 g of the alcohol-washed soybean protein concentrate was dissolved in 82.75 g of water for ultrasonic treatment at different powers. The time for a single ultrasonic treatment was 3 s, and the interval time therebetween was 3 s. The solution after ultrasonic treatment may be directly subjected to the subsequent preparation of emulsified liquid or freeze-drying to be used as raw material. Microfluidization: 3.6 g of the alcohol-washed soybean protein concentrate was dissolved in 82.75 g of water for microfluidization for different times. The solution after microfluidization may be directly subjected to the subsequent preparation of emulsified liquid or freeze-drying to be used as raw material. Cavitation: 3.6 g of the alcohol-washed soybean protein concentrate was dissolved in 82.75 g of water for cavitation treatment for different durations. The solution after cavitation may be directly subjected to the subsequent preparation of emulsified liquid or freeze-drying to be used as raw material. Ball milling: the alcohol-washed soybean protein concentrate was directly placed in a ball mill for dry milling at a speed of 300 r/min, and the protein was collected after dry milling.

Determination method of solubility: 1 g of the alcohol-washed soybean protein concentrate was dissolved in 100 ml of water and stirred thoroughly for 2 h. A certain amount of protein solution was taken for the determination of total protein content (Kjeldahl method). The protein solution was centrifuged at a rotating speed of 8,000 rpm for 20 min using a centrifuge to obtain a supernatant, and the protein content in the supernatant was measured by the Kjeldahl method. Solubility of protein=Protein content in supernatant/Total protein content×100%.

Results of the influences of different pretreatments on the solubility of alcohol-washed soybean protein concentrate are shown in Table 4.

TABLE 4
Influences of different pretreatments on solubility of alcohol-washed soybean protein concentrate

| | | Ultrasonic | Ultrasonic | Ultrasonic | Micro- | Micro- | Micro- |
|---|---|---|---|---|---|---|---|
| | | treatment | treatment | treatment | fluidization | fluidization | fluidization |
| Treatment | Without | (200 W, | (400 W, | (600 W, | (50 MPa, | (50 MPa, | (50 MPa, |
| method | treatment | 10 min) | 10 min) | 10 min) | once) | 2 times) | 3 times) |
| Solubility | 5.6% | 8.2% | 8.9% | 8.7% | 6.1% | 6.3 | 6.5% |

| | | | | | | | Ball |
|---|---|---|---|---|---|---|---|
| | | | | | | | milling |
| | | | | Ball | Ball | Ball | for 1 h + |
| Treatment | Cavitation | Cavitation | Cavitation | milling | milling | milling | cavitation |
| method | (5 min) | (10 min) | (20 min) | (20 min) | (40 min) | (1 h) | for 20 min |
| Solubility | 10.4% | 11.2% | 12.1% | 12.5% | 13.1% | 13.5% | 15.6% |

It can be seen from Table 4 that different pretreatments have different degrees of improvement effects on the solubility of soybean protein. Generally speaking, ball milling>cavitation>ultrasonic treatment>microfluidization, and the combined use of ball milling and cavitation exhibits a synergistic effect in enhancing the solubility.

### Example 3: Influences of Different Pretreatments of Alcohol-Washed Soybean Protein Concentrate on Emulsified Liquids

The alcohol-washed soybean protein concentrate was subjected to different pretreatments, as shown in Table 5. A carbohydrate (maltodextrin), a dietary fiber (resistant dextrin), a water-soluble vitamin, and a mineral were added according to Table 2, and the pH was adjusted to 7 using 0.5 M sodium hydroxide or 0.5 M hydrochloric acid to obtain an aqueous phase. An oil-soluble vitamin was dissolved in sunflower seed oil to obtain an oil phase. The aqueous phase and the oil phase were mixed, and after pre-homogenization shearing at a rate of 6,000 rpm for 2 min high-pressure microfluidization was performed for three times at a condition of 50 MPa. After the emulsified liquid was canned, high-pressure steam sterilization was performed (121 °C, 15 min) to obtain an emulsion.

TABLE 5
Influences of different pretreatments of alcohol-washed
soybean protein concentrate on emulsified liquids

| | | Appearance | Appearance |
|---|---|---|---|
| | | (before | (after |
| Sample | Pretreatment | sterilization) | sterilization) |
| 7 | Ultrasonic treatment (400 W, | + | +++ |
| | 10 min) | | |
| 8 | Microfluidization (50 MPa, | ++ | ++++ |
| | 3 times) | | |
| 9 | Cavitation (20 min) | − | + |
| 10 | Ball milling (300 r/min, 1 h) | − | − |

It can be seen from Table 5 that when using alcohol-washed soybean protein concentrate subjected to ultrasonic pretreatment as the raw material, the emulsified liquid exhibits slight phase separation and flocculation. The emulsified liquid obtained after microfluidization pretreatment exhibits severe floating oil, phase separation, or flocculation. After sterilization, both exhibit severe instability. The emulsions prepared from raw materials treated by cavitation and ball milling exhibit uniform appearance and good fluidity, with no obvious phase separation and flocculation. However, after sterilization, the samples prepared from raw materials treated by cavitation exhibit slight flocculation and phase separation, while those prepared from raw materials treated by ball milling exhibit good stability without instability. The appearance of samples 7-10 before sterilization is shown in FIG. 2.

### Example 4: Influences of Enzymatic Hydrolysis Using Different Types of Enzymes on Emulsified Liquids

The alcohol-washed soybean protein concentrate after ball milling (300 r/min, 1 h) was subjected to enzymatic hydrolysis. The specific enzymatic hydrolysis method is shown in Table 6. The addition amount of the enzyme was 1% in terms of the protein mass. After enzymatic hydrolysis, the enzyme was inactivated in a water bath at 90 °C for 10 mi to terminate the reaction. A carbohydrate (maltodextrin), a dietary fiber (resistant dextrin), and a water-soluble vitamin were added according to Table 1, and the pH was adjusted to 7 using 0.5 M sodium hydroxide or 0.5 M hydrochloric acid to obtain an aqueous phase. An oil-soluble vitamin was dissolved in sunflower seed oil to obtain an oil phase. The aqueous phase and the oil phase were mixed, and after pre-homogenization shearing at a rate of 6,000 rpm for 2 mi, high-pressure microfluidization was performed for three times at a condition of 50 MPa. After the emulsified liquid was canned, high-pressure steam sterilization was performed (121 °C, 15 min) to obtain the emulsion.

TABLE 6
Influences of different enzymatic hydrolysis treatments on emulsified
liquids with alcohol-washed soybean protein concentrate

| | | Appearance | Appearance |
|---|---|---|---|
| | | (before | (after |
| Sample | Enzymatic hydrolysis treatment | sterilization) | sterilization) |
| 11 | Cellulase (time for enzymatic | + | ++ |
| | hydrolysis of 1 h, temperature for | | |
| | enzymatic hydrolysis of 50 °C, and | | |
| | pH of 7) | | |
| 12 | Papain (time for enzymatic | + | ++ |
| | hydrolysis of 1 h, temperature for | | |
| | enzymatic hydrolysis of 50 °C, and | | |
| | pH of 7) | | |
| 13 | Alkaline protease (time for | − | +++ |
| | enzymatic hydrolysis of 1 h, | | |
| | temperature for enzymatic | | |
| | hydrolysis of 50 °C, and pH of 9) | | |
| 14 | Neutral protease (time for | − | − |
| | enzymatic hydrolysis of 1 h, | | |
| | temperature for enzymatic | | |
| | hydrolysis of 50 °C, and pH of 7) | | |

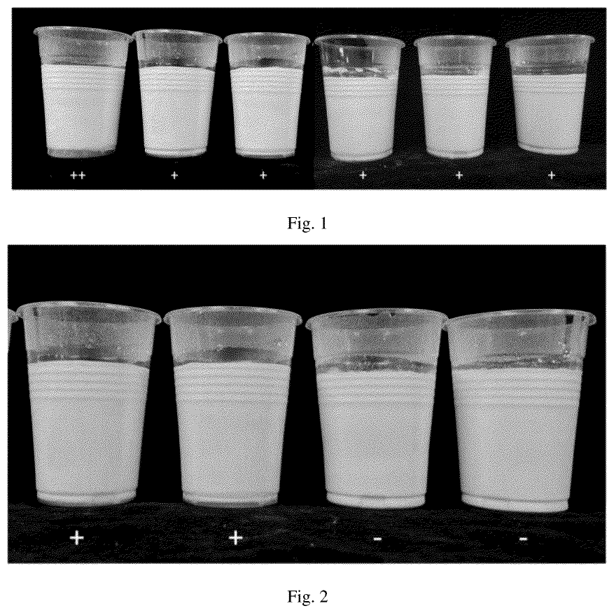

It can be seen from Table 6 that the enzymatic hydrolysis treatment can effectively improve the stability of the emulsified liquids with soybean protein concentrate. Samples 11 and 12 were subjected to enzymatic hydrolysis using cellulase and papain, respectively. After homogenization, slight phase separation or flocculation occurred at the bottom of the emulsified liquid. After sterilization, obvious floating oil, phase separation, or flocculation appeared. Sample 13 was subjected to enzymatic hydrolysis using alkaline protease. After homogenization, there was no floating oil, phase separation, or flocculation. However, obvious floating oil, phase separation, or flocculation appeared after sterilization. Sample 14 was subjected to enzymatic hydrolysis using neutral protease. After homogenization, there was no floating oil, phase separation, or flocculation, forming a stable emulsified liquid. After sterilization, there was still no floating oil, phase separation, or flocculation, and the stability was good. The appearance of samples 11-14 after sterilization is shown in FIG. 3.

### Example 5: Stability Investigation of Nutritional Emulsion with Alcohol-Washed Soybean Protein Concentrate Subjected to Pretreatment and Enzymatic Hydrolysis

3.6 g of protein subjected to dry ball milling (300 r/min) for 1 h was weighed, dissolved in 82.75 g of water, and stirred evenly for hydrodynamic cavitation treatment (20 min). 0.4% of Neutral protease in terms of the protein mass was added to the obtained solution for enzymatic hydrolysis for 2 h at 50 °C. After enzymatic hydrolysis, the enzyme was inactivated in a water bath at 90 °C for 10 min to terminate the reaction. A carbohydrate (maltodextrin), a dietary fiber, a water-soluble vitamin, and mineral were added according to Table 2, and the pH was adjusted to 7 using 0.5 M sodium hydroxide or 0.5 M hydrochloric acid to obtain an aqueous phase. An oil-soluble vitamin was dissolved in sunflower seed oil (lipid, i.e. fat) to obtain an oil phase. The aqueous phase and the oil phase were mixed, and after pre-homogenization shearing at a rate of 6,000 rpm for 2 min, high-pressure microfluidization was performed for three times at 50 MPa. After the emulsified liquid was canned, high-pressure steam sterilization was performed (121 °C, 15 min) to obtain the emulsion. The emulsion was stored at room temperature for 3 months to observe the stability of the emulsion. The results are shown in FIG. 4.

It can be seen from FIG. 4 that the nutritional emulsion prepared by ball milling and cavitation pretreatment of the raw material protein, and enzymatic hydrolysis using neutral protease can still maintain better stability after being placed for 3 months.

Finally, it should be noted that the foregoing examples are preferred embodiments of the present disclosure and are not intended to limit the present disclosure. Any modifications, equivalent substitutions, or combinations made without departing from the spirit and principle of the present disclosure are included within the protection scope of the present disclosure.

1. A liquid nutritional emulsion stabilized by alcohol-washed soybean protein concentrate, comprising 2-8 g of the alcohol-washed soybean protein concentrate, 5-10 g of a carbohydrate, 2-4 g of a dietary fiber, 4-8 g of a lipid, 0.05-0.2 g of multivitamin, and 0.5-2 g of complex minerals per 100 mL of the liquid nutritional emulsion;
wherein the carbohydrate is one or more selected from a group consisting of maltodextrin, trehalose, corn starch, glucose, sucrose, lactose, polydextrose, inulin, and isomaltooligosaccharide;
the dietary fiber is resistant dextrin;
a preparation method of the liquid nutritional emulsion stabilized by alcohol-washed soybean protein concentrate comprises the following steps:
1) mixing the alcohol-washed soybean protein concentrate with water, performing pretreatment and enzymatic hydrolysis, then adding the carbohydrate, dietary fiber, water-soluble vitamins, and minerals, and adjusting the pH to 6.5-7 to obtain an aqueous phase, wherein the pretreatment involves dry ball milling of the alcohol-washed soybean protein concentrate for 0.5-1 h, followed by hydrodynamic cavitation for 10-20 min, a rotating speed of the ball milling being 200-400 r/min; the enzyme used for enzymatic hydrolysis is neutral protease, and conditions of enzymatic hydrolysis are as follows: an addition amount of the enzyme is 0.4-4% of the mass of the alcohol-washed soybean protein concentrate, the enzymatic hydrolysis time is 0.5-4 h, and the enzymatic hydrolysis temperature is 40-70 °C; after enzymatic hydrolysis, the enzyme is inactivated in a water bath at 89-95 °C for 10 min to terminate the reaction;
2) adding oil-soluble vitamins to the oil, and mixing uniformly to obtain an oil phase; and
3) mixing the aqueous phase and the oil phase, performing pre-homogenization shearing for 1-5 min at a rotating speed of 3,000-10,000 rpm, and then performing high-pressure microfluidization 2-4 times at 30-100 MPa, followed by sterilization, to obtain the nutritional emulsion.

2.-3. (canceled)

4. The liquid nutritional emulsion stabilized by alcohol-washed soybean protein concentrate according to claim 1, wherein the multivitamin comprises an oil-soluble vitamin and a water-soluble vitamin, and specifically comprises vitamin A, vitamin C, vitamin D, vitamin E, vitamin K, vitamin B₁, vitamin B₂, vitamin B₆, vitamin B₁₂, niacins, folic acid, pantothenic acid, and biotin;
the water-soluble vitamin comprises vitamin B₁, vitamin B₂, vitamin B₆, vitamin B₁₂, niacin, folic acid, pantothenic acid, vitamin C, and biotin; and the oil-soluble vitamin comprises vitamin A, vitamin D, vitamin E, and vitamin K₁.

5. The liquid nutritional emulsion stabilized by alcohol-washed soybean protein concentrate according to claim 4, wherein contents of various vitamins in the multivitamin per 100 mL of the nutritional emulsion are as follows: vitamin A 28.2-242.1 μg RE, vitamin D 0.57-3.385 μg, vitamin E 0.57-2.25 mg α-TE, vitamin K₁ 3.15-4.5 μg, vitamin B₁ 0.06-0.9 mg, vitamin B₂ 0.06-0.9 mg, vitamin B₆ 0.06-0.9 mg, vitamin B₁₂ 0.09-1.35 μg, niacin 0.15-1.8 mg, folic acid 15.9-45 μg, pantothenic acid 0.21-2.7 mg, vitamin C 3.9-40.5 mg, and biotin 1.5-5.4 μg.

6. The liquid nutritional emulsion stabilized by alcohol-washed soybean protein concentrate according to claim 1, wherein the complex minerals comprise sodium, potassium, copper, magnesium, iron, zinc, manganese, calcium, phosphorus, iodine, chlorine, and selenium salts.

7.-8. (canceled)

9. The preparation method for the liquid nutritional emulsion stabilized by alcohol-washed soybean protein concentrate according to claim 1, wherein the sterilization refers to high-pressure steam sterilization at a temperature of 110-125 °C for 5-15 min.

10. (canceled)

11. The liquid nutritional emulsion stabilized by alcohol-washed soybean protein concentrate according to claim 1, wherein the oil is selected from one or more of corn oil, sunflower seed oil, soybean oil, low-erucic-acid rapeseed oil, sesame oil, sea buckthorn oil, linseed oil, coconut oil, olive oil, perilla oil, palm oil, walnut oil, rice oil, camellia seed oil, fish oil, and medium chain triglyceride.
